(19) United States
(12) Patent Application Publication
(10) Pub. No.: US 2023/0028817 A1
(43) Pub. Date: Jan. 26, 2023

(54) METHOD AND APPARATUS FOR FORMING A TRENCH FOR CABLE INSTALLATION

(71) Applicant: Diona Construction LTD, Glasgow (GB)

(72) Inventor: William DOCHERTY, Glasgow (GB)

(21) Appl. No.: 17/785,962

(22) PCT Filed: Dec. 16, 2020
(86) PCT No.: PCT/GB2020/053245

§ 371 Date: Jun. 16, 2022

(30) Foreign Application Priority Data
Dec. 16, 2019 (GB) 1918542.0

(51) Int. Cl. E01C 23/09; E02F 5/08; E02F 5/10; B28D 1/04; B23C 3/00

(52) U.S. Cl. CPC E01C 23/0966; E02F 5/08; E02F 5/10; B28D 1/045; B28D 1/048; B23C 3/002; H02G 1/06

(57) ABSTRACT

A blade drive shaft assembly (100) for a road saw comprising a shaft (120), a first mounting plate (125), a spacer removably fitted (126) on the shaft (120), a second mounting plate (127) removably fitted on the shaft (120), a mounting plate fixing adapted to secure the second mounting plate (127) to the shaft, a first circular saw blade mounted between the first mounting plate and the spacer (126), and a second circular saw blade mounted between the second mounting plate (127) and the spacer (126), wherein the first mounting plate (125) is integrally formed with the shaft (120) from a single piece of metal. A road saw incorporating the assembly is also described, as well as a method of forming, filling and compacting a trench and a method of making a blade drive shaft assembly.

### BACKGROUND OF THE INVENTION

The present invention relates to a saw for forming a trench in the ground for laying cables in, and a method of forming such a trench.

Various types of electrical and data transmission cables are required to be laid underground. Examples of such cables include fibre-optic cables for high-speed transmission of data. Placement of such cables underground can significantly improve their reliability and impact on the environment, when compared with running the cables by the use of pylons, for example. Pylons and other forms of fixed structures to assist overground positioning of cables are susceptible to damage in severe weather, and are unsightly. The reliability of underground cables greatly depends on their proper installation. The installation process often involves disruption to transport infrastructure and causes inconvenience to people in the vicinity of the cable installation. Furthermore, the installation process absorbs a significant proportion of the budget for a cable installation project, as the manual work involved in digging and filling the trench is significant with respect to the time and equipment required to lay the cable within the trench.

Typically, a trench is formed in concrete or tarmac by engagement of a road saw with the ground. Typical road saws have a single blade, and an operator must make two separate passes with the road saw to for the trench. It is known to provide a road saw with two circular saw blades which are spaced apart within a safety enclosure forming a guard around the circular saw blades. As a brief overview of the trench digging operation, the operator aligns the road saw and starts the engine to drive the shaft to which the circular saw blades are attached. The road saw is moved along a path to cut a trench. There are various materials which can be used to fill the trench, however it is common for the cables to be installed in a bed of sand. The bed of sand is typically then covered with one or more layers of type 1 backfill and a base layer, and then a layer of tarmac or asphalt on top of the cement. The backfill material is typically placed in layers of 150 mm depth. The top layer, hereinafter referred to as the surface layer, may require compaction by vibrating plate and roller. During backfill, the layers of backfill material may require compaction by a rammer. The rammer is used to compress the aggregate material, increasing the density of said material and ensuring that post laying settlement does not occur. There are several problems with the known equipment and methods for trench construction and completion. Standard single blade road saws require at least two passes of the road saw to cut a trench, and the cutting lines must be accurately marked to ensure an even trench width. Furthermore, prior art twin blade road saws are limited in the width of trench they can cut. This limitation comes from the requirement that the road saw remains portable and light enough to be carried/lifted by the operator. There are therefore design limitations on the weight of the materials. This problem is compounded by the fact that road saws are typically driven be a horizontal drive shaft, with the drive shaft extending from a bearing and carrying the two circular saw blades in a cantilever fashion. The horizontal spacing of the two circular saw blades is limited by the bending moment created by a heavy blade, and associated bearings, spacers etc., being positioned distant from the drive mechanism. Moreover conventional rammers require a large base plate, with a footprint having a width which does not fit within the trench formed by a prior art twin blade road saw, so that the backfill material in such a trench cannot be compacted properly.

If a wider trench is to be cut, then the usual practice is to use a single blade road saw. However such trenches may have an uneven width, and may be substantially greater than the width of the footprint of a base plate. a Because of the aforementioned disruption to the public/transport infrastructure, and the fact that operators are often paid for the job rather than their time, there is a tendency to avoid making two passes with the rammer if possible. However this leads to a poor quality compaction of the trench, thus leading to the aforementioned problems.

It is an object of the present invention to provide a blade drive shaft, and a road saw comprising this blade drive shaft, which overcome at least one of the aforementioned problems. It is a further object of the present invention to provide a method of forming, filling and compacting a trench which overcomes at least one of the aforementioned problems.

### SUMMARY OF THE INVENTION

According to a first aspect of the invention there is provided a blade drive shaft assembly for a road saw. The blade drive shaft comprises a shaft, a first mounting plate, a spacer removably fitted on the shaft, a second mounting plate removably fitted on the shaft, a mounting plate fixing adapted to secure the second mounting plate to the shaft, a first circular saw blade mounted between the first mounting plate and the spacer, and a second circular saw blade mounted between the second mounting plate and the spacer, wherein the first mounting plate is integrally formed with the shaft from a single piece of metal. This assembly has the benefit of being strong and light. The integrally formed first mounting plate provides strength compared to a first mounting plate welded to a blade drive shaft.

Preferably, the shaft has a diameter greater than 25 mm, and more preferably a diameter of between 26 mm and 35 mm. The strength provided by the integrally formed first mounting plate and blade drive shaft can be utilised to allow the assembly to carry additional weight and bending moment. In this regard, the blade drive shaft can be increased in diameter to further increase the strength of the assembly.

Preferably, the blade drive shaft and the first mounting plate comprise EN19 hardened steel, which is a strong material and is readily available. Furthermore, the material provides a good compromise between weight and strength, which makes it particularly suitable for the portable equipment which must be lifted by a single operator.

According to a second aspect of the invention there is also provided a road saw for cutting a trench in a road. The road saw comprises a road saw body; an engine mounted to the road saw body; a blade drive shaft assembly according to the first aspect rotatably supported by a bearing mounted to the road saw body; a transmission means driveably coupling the engine and the shaft; wherein the first mounting plate, the spacer, the second mounting plate and the first and second circular saw blades are provided on a portion of the shaft cantilevered from the bearing, wherein the first and second blades are arranged 200 mm apart. The road saw provided has improved strength which allows the road saw to carry circular saw blades which are separated by a greater separation than was previously possible, and can therefore cut a trench of larger width than was previously possible. The road saw body provides support such that the blade drive shaft can be carried and operated by the user. The engine, bearing and transmission means provide a driving mechanism such that the blade drive shaft can be driven with the required torque and power.

The spacer axial length provides the separation between the first and second circular saw blades, which provides that the trench cut will be of a greater width than previously possible and can be cut in one cutting operation. There are multiple benefits to a wider trench in one cutting operation. Firstly, a wide trench cut in one pass saves time which saves costs and disruption to the public and infrastructure in the vicinity of the operation, and secondly, a wider trench which is subsequently filled with aggregate material ensures that the operator must make two passes with a rammer to compact the aggregate material, thus providing a better quality fill.

Optionally, the road saw may comprise an adapter for use in conjunction with the spacer, and for providing additional separation between the first and second circular saw blades. This allows the blade separation to be easily adjusted for particular jobs and requirements. This saves the cost of the construction company owning or renting multiple road saws of different blade separations, and allows one road saw to be sent to a job which requires trenches of different widths to be cut.

According to a third aspect of the invention there is provided a method of forming, filling and compacting a trench comprising the steps of: providing a road saw of the second aspect; cutting a trench having a width of at least 200 mm using said road saw; at least partially filling said trench with aggregate material; and compacting a total portion of said aggregate material by passing over the aggregate material with a rammer comprising a footprint with a width less than the width of the trench. This ensures that not all of the aggregate material is compacted as the rammer is passed over the trench. This provides the benefit that the operator must make a second pass to compact the aggregate material left uncompacted after the first pass. This provides a better quality fill of the trench. In this regard it is preferable that the width of the footprint may be at least 30 mm less than the width of the trench, thus ensuring that a visible area of uncompacted aggregate material is left after the first pass, therefore ensuring that the operator must make a second pass.

Preferably the road saw is a road saw according to the second aspect.

Preferably, the step of compacting a total portion of said aggregate material comprises the steps of: compacting a first portion of the total portion with the rammer in a first pass; and compacting a second portion of the total portion with the rammer in a second pass; wherein the first and second portions at least partially cover the same area of aggregate material in a third portion. The third portion which comprises part of the first and second portions may be compacted in the first pass and the second pass. This ensures that the overlapping third portion is compacted with the rammer at least twice, which provides a high quality fill in this portion of the trench.

Optionally, the steps of compacting the first portion and compacting the second portion may together complete the compaction of all of the aggregate material in the trench. This provides that the method cuts, fills and compacts an entire trench, leading to the completion of the job with a high quality fill of the trench.

According to a fourth aspect of the invention, there is provided a method of forming a blade drive shaft for a road saw, comprising the steps of providing a block of raw material and milling the raw material to provide a shaft and an integral first mounting plate. This provides a strong blade drive shaft which can carry increased weight and bending moments, thus allowing for an increased diameter of shaft to be used which further increases the strength of the shaft and allows road saw blades to be positioned further apart on said blade drive shaft.

Preferably, the raw material may be EN19 steel. This is a strong material and is readily available. Furthermore, the material provides a good compromise between weight and strength, which makes it particularly suitable for a drive shaft for the portable equipment which must be lifted by a single operator. Additionally, the material can be hardened after being milled. In this regard, it is preferable that the method may further comprise the step of hardening the blade drive shaft, thus further improving its properties for application in a road saw. Preferably the blade drive shaft so formed is used in the method of making a blade drive shaft assembly according to the first aspect.

### BRIEF DESCRIPTION OF AND INTRODUCTION TO THE DRAWINGS

Embodiments of the invention will now be described by way of example only with reference to the accompanying drawings in which:

FIG. 1 shows a prior art road saw;

FIG. 2 shows a known rammer;

FIG. 3 shows an exploded view of some components of the prior art road saw of FIG. 1;

FIG. 4 shows an exploded view of some components, including the blade drive shaft assembly, of the prior art road of FIG. 1;

FIG. 5 shows an exploded view of a blade drive shaft assembly in accordance with the first aspect of the present invention; and

FIG. 6 shows a method of forming, filling and compacting a trench in accordance with a second aspect of the present invention.

### DETAILED DESCRIPTION

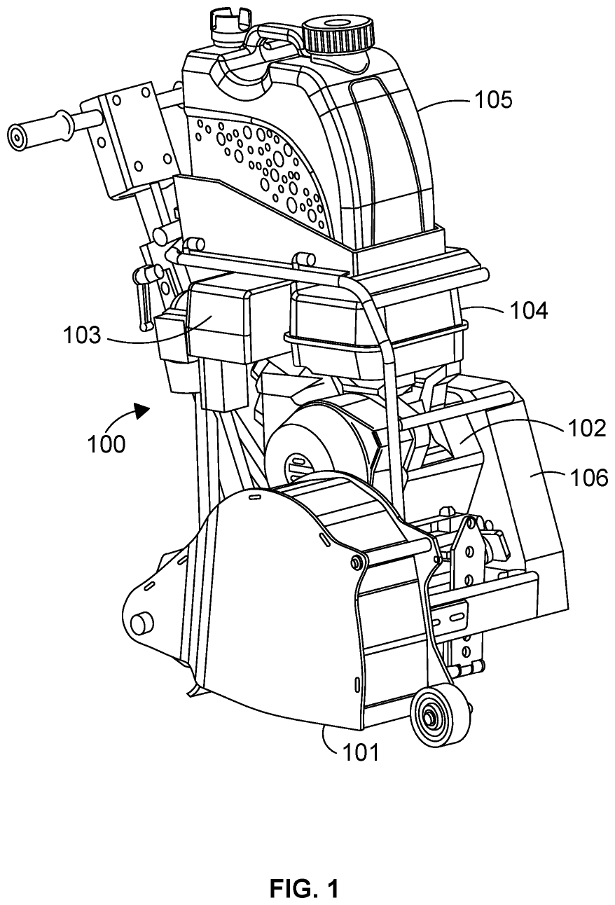

FIG. 1 shows a prior art twin blade road saw 100. The main components of the road saw are a blade guard 101 for covering the circular saw blades of the saw during operation, an engine 102 for driving the circular saw blades of the saw, an exhaust 103, a fuel tank 104, a water tank 105 and a belt guard 106. The road saw 100 comprises a road saw body for mounting the engine. The road saw body may comprise a frame like structure and may comprise additional components added to the structure for a particular job.

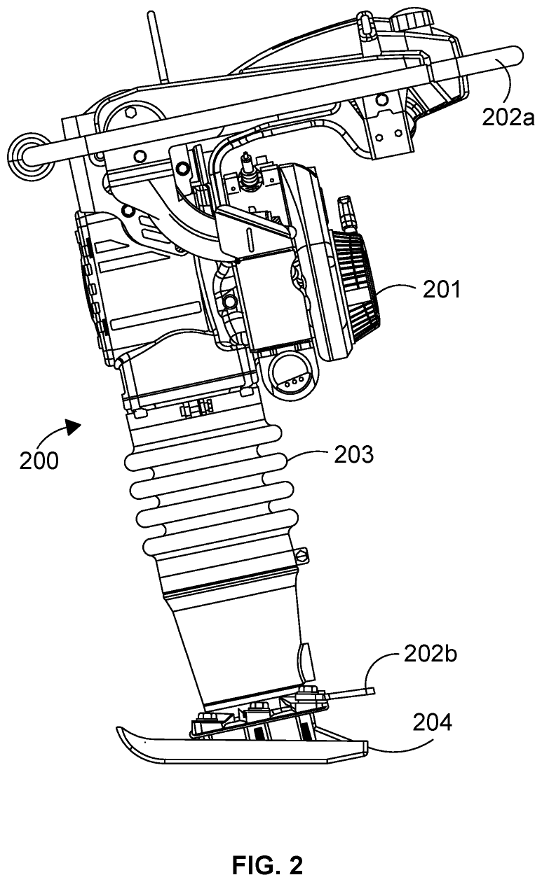

Referring now to FIG. 2, which shows a known rammer 200 for providing compaction to the surface layer of a trench. The main components of the rammer 200 are an engine 201, a handle 202a and footrest 202b for moving and stabilising the rammer 200 when in use, an actuating section 203 and a footprint 204. The footprint 204 provides an impacting force over a substantially flat square or rectangular area. The rapid movement of the actuating section 203 to contract and expand the rammer total length provides rapid impacts to the surface being rammed.

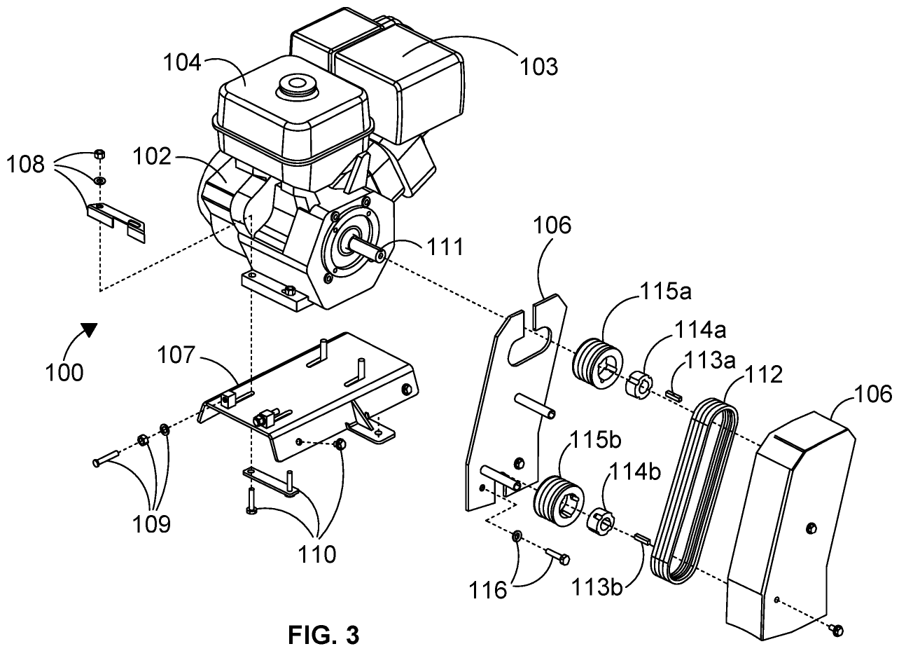

Referring now to FIG. 3, which shows an exploded view of components of the prior art road saw 100 of FIG. 1. The engine 102 is mounted and securely attached to an upper bedplate 107 by a series of screw/nut, washer and bracket arrangements 108, 109, 110. A transmission means is now described which provides drive to the blade drive shaft. The drive shaft 111 of the engine 102 protrudes into the belt guard 106 to drive a belt 112 through a standard arrangement of upper key 113a, bush 114a and pulley member 115a. The belt 112 translates the drive from the drive shaft 111 to a blade drive shaft (not shown), via a lower key 113b, bush 114b and pulley member 115b. The blade drive shaft (not shown) turns the circular saw blades to cut the surface being trenched. In this regard, the blades are attached to the blade drive shaft by welding or using another attachment means. The belt guard 106 is attached to the upper bedplate 107 by bolts/washers 116.

The bush 114b that sits within the pulley member 115b has an internal bore of around 25.4 mm to allow passage of the blade drive shaft 120 therethrough, and may further comprise an internal surface feature which is registered to mate with a feature of the blade drive shaft 120 to allow the bush 114b to engage with the blade drive shaft 120 to turn the blade drive shaft 120. Typically, the pulley member 115b has an external diameter of around 85 mm, and an axial length of around 85 mm. It will be understood that this is just one of a plurality of possible transmission means which can be used to drive the drive shaft.

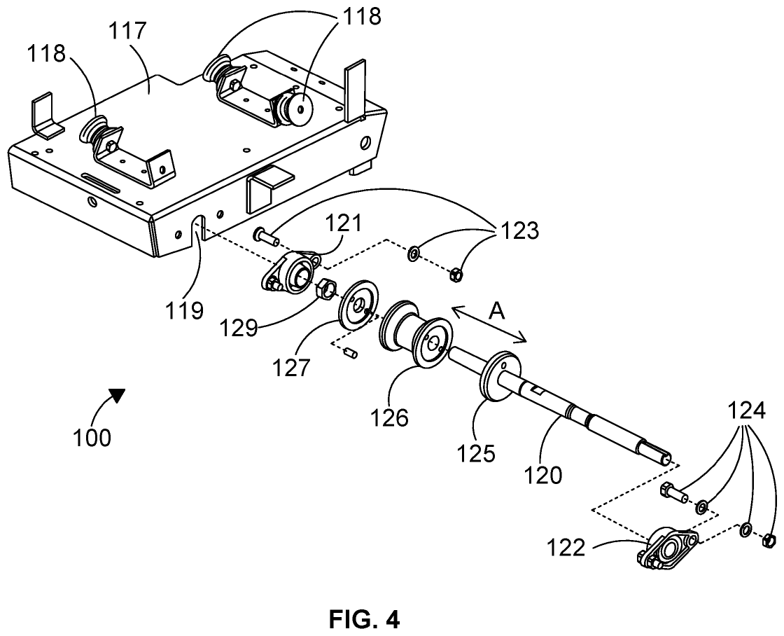

Referring now to FIG. 4, which shows an exploded view of other components of the prior art road saw 100 of FIG. 1, including an exploded view of a blade drive shaft assembly. There is shown a lower bed plate 117 which attaches to the upper bed plate 107 via anti-vibration mounts 118. The lower bed plate 117 also attaches to the main chassis (not shown) of the road saw 100. The lower bed plate 117 provides a slot 119 through which the blade drive shaft 120 extends. As will be understood with reference to FIG. 1, when in the operational, assembled, configuration the blade drive shaft 120 is housed within the belt guard 106, the lower bed plate 117 and the blade guard 101, and the blade drive shaft 120 extends across the width of the saw 100. In this regard, the blade drive shaft 120 is driven by the belt 112 on one side of the saw 100 and delivers power to the circular saw blades (not shown) located at the other side of the saw 100. The blade drive shaft 120 is mounted within multiple bearing assemblies 121, 122, and corresponding fixing means 123, 124 to secure the bearing assemblies 121, 122 and blade drive shaft 120 in place within the lower bed plate 117, whilst a protruding region A of the blade drive shaft 120 protrudes from within the lower bed plate 117. The protruding region A accommodates the two circular saw blades (not shown) and allows the two blades to rotate within the blade guard 101. The protruding region A is a cantilevered portion when the blade drive shaft 120 is assembled in the road saw 100. In this regard, the two circular blades (not shown) are secured to the blade drive shaft 120 such that the two blades will rotate with the blade drive shaft 120 during operation of the road saw 100. A first circular saw blade (not shown) is mounted on the blade drive shaft 120 between a first mounting plate 125 and a spacer 126. A second circular saw blade (not shown) is mounted on the blade drive shaft 120 between a second mounting plate 127 and the spacer 126. The spacer 126 serves to space the first and second circular saw blades a fixed distance, and the first and second mounting plates 125, 127 serve to secure the first and second circular saw blades in the axial direction of the blade drive shaft 120.

The standard order of assembly of some of the components is now described, still with reference to FIG. 4. In assembling the protruding region A of the blade drive shaft 120, the first mounting plate 125 is firstly fixedly attached to the blade drive shaft 120. The blade drive shaft 120 is typically formed of two separate shaft components, each welded together and welded to the first mounting plate 125, or each, or each welded to opposite sides of the first mounting plate. This results in an inherent weakness in the shaft 120 at the point of maximum bending moment, i.e. the root of the cantilever portion or protruding region A. The first circular saw blade (not shown) is then mounted on the blade drive shaft 120 and secured adjacent the first mounting plate 125. The spacer 126 is then mounted on the blade drive shaft 120, and is secured to the first circular saw blade and first mounting plate 125 by known fixing means such as a nut and bolt arrangement. The second circular saw blade (not shown) is then mounted on the blade drive shaft 120 adjacent the spacer 126. The second mounting plate 127 is then mounted on the blade drive shaft 120 and the spacer 126, the second circular saw blade and the second mounting plate 127 are secured by known fixing means such as a nut and bolt arrangement. A pin 128 may be located in corresponding holes of the second mounting plate 127, spacer 126 and second circular saw blade. A similar pin (not shown) may be used with the first mounting plate 125, spacer 125 and first circular saw blade. The final step in the assembly of the protruding region A is the attaching of a nut 129 which is mounted on a threaded end portion of the protruding region A. The threaded end portion allows the nut 129 to be tightened on the protruding region A to secure and bias the second mounting plate 127, second circular saw blade, spacer 126 and first circular saw blade against the first mounting plate 125. The nut 129 may also be accompanied by a corresponding washer. When assembled in the road saw 100, the protruding region A is cantilevered from the bearing assembly 121.

Typically, the blade drive shaft 120 is 25 mm in diameter and around 598 mm in length. A blade guard 101 of around 167 mm in width is typically used with a blade drive shaft of 598 mm. The first mounting plate 125 (which is welded to the blade drive shaft 120) has an outer diameter of around 65 mm. The spacer 126 has an internal bore of 25.4 mm diameter, through its longitudinal axis. The spacer 126 has an outer diameter of around 98 mm at each end, adjacent the first circular saw blade and second circular saw blade. This large outer diameter is require to steady and support the first and second circular saw blade. The spacer 126 may have a reduced outer diameter through the centre of the spacer 126 where no support of the circular saw blades is required, thus reducing the weight of the spacer 126 and overall weight of the saw 100. The spacer 126 has an axial length of around 100 mm, thus the first and second circular saw blades are spaced apart around 100 mm. The second mounting plate 127 has an outer diameter of around 65 mm and an internal bore of 25.4 mm. The bearing assemblies 121, 122 have an internal bore of 25.4 mm to also allow the blade drive shaft 120 to pass therethrough.

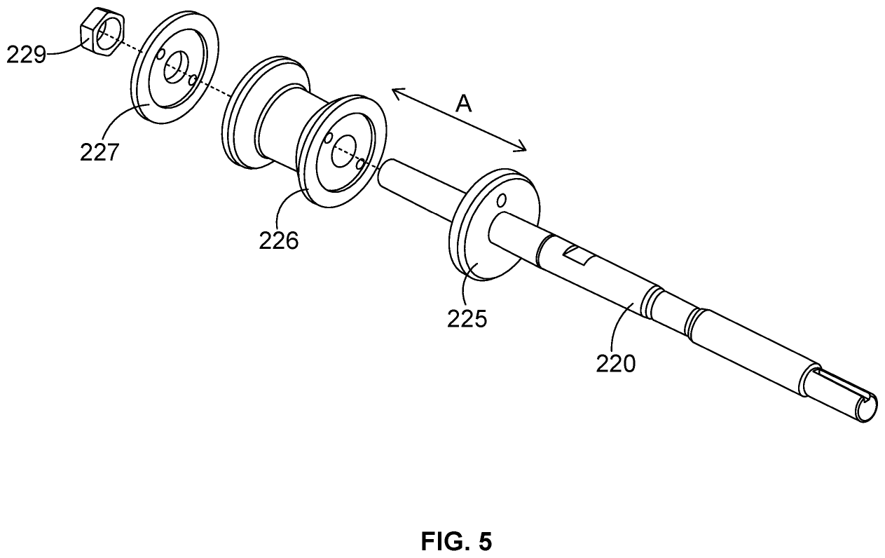

Referring now to FIG. 5 which shows blade drive shaft 220 of a road saw 200 in accordance with the present invention, which has all of the components of the prior art road saw 100 of FIGS. 1 to 4, with various modifications. Firstly, the first mounting plate 225 is integrally formed with the blade drive shaft 220 by milling the blade drive shaft 220 and integral first mounting plate 225 from one piece of material, typically metal, and preferably EN19 hardened steel. Both portions of the drive shaft 220, either side of the first mounting plate 225, are formed from the single piece of material. Other materials such as composites or hard plastic materials are envisaged. This greatly improves the strength of the first mounting plate 225 when compared with a first mounting plate 125 which has been welded to a blade drive shaft 120. In particular the likelihood of fatigue cracks at the root of the cantilever is reduced, by eliminating a weld joint at this location. Furthermore, the blade drive shaft 220, and integral first mounting plate 225, may preferably be hardened after milling, to further improve the strength of the blade drive shaft 220. The integral first mounting plate 225 has a diameter of around 92 mm.

The blade drive shaft 220 is further configured for improved strength by means of an increased diameter of 30 mm. This provides a stronger shaft which can withstand higher loads and carry additional weight and/or additional bending moments. This provides an advantage over lower diameter shafts by providing the option of positioning the second circular saw blade further away from the first circular saw blade, as the blade drive shaft 220 can now carry the additional weight and bending moment created by the further away second circular saw blade.

In this regard, the other components located in the protruding region A are also adapted to receive the increased diameter blade drive shaft 220. The spacer 226 has an internal bore of 30.4 mm diameter, through its longitudinal axis. The spacer 226 has an outer diameter of around 100 mm at each end, adjacent the first circular saw blade and second circular saw blade. The spacer 226 has an axial length of around 200 mm, thus spacing the first and second circular saw blades 200 mm apart. This increased spacing can be achieved by the aforementioned increased blade drive shaft 220 diameter, and the stronger integrally formed first mounting plate 225. As previously described, the arrangement transfers large loads to the first mounting plate 225 as the first and second circular saw blades, second mounting plate 227 and spacer 226 are all biased against the first mounting plate 225 by the nut 229. The stronger integrally formed first mounting plate 225 therefore allows the axial length of the spacer 226 to be increased, and the resulting spacing of the first and second circular saw blades to be increased. The second mounting plate 227 is configured to have an increased outer diameter of around 92 mm and an increased internal bore of 30.4 mm to accommodate the increased blade drive shaft 226 diameter.

As a result of the increased load capabilities, the blade drive shaft 220 has an increased length of around 698 mm, allowing for the increased spacer 226 axial length. The length of the blade drive shaft 220 may be increased further to accommodate greater blade separation. In this regard, the spacer 226 may also be increased in axial length, or additional spacers may be added in the form of adapters to increase the separation of the circular saw blades. Different sizes of adapters may be configured to be compatible with the blade drive shaft and associated components of protruding region A. In this regard, a road saw 200 may be provided with a plurality of varying axial length adapters, such that the operator of the blade saw can select the appropriate adapter or adapters for the desired trench width. This allows the road saw 200 to be quickly and easily adapted, and allows for one road saw 200 to be used to cut a plurality of trench widths, rather than requiring many different road saws for different widths. A blade guard of around 267 mm in width is typically used with a blade drive shaft of 698 mm. The blade guard may be further configured with two guide indicators on the outside of the blade guard, i.e. on the side, and located at a position, such that the indicators are visible to the operator when in use. The guide indicators (not shown) may be moveable across the width of the blade guard, such that each indicator can be positioned to indicate the position of the respective blade to the operator. This allows the operator to be certain of the position of the blade when performing the trench cutting operation. This is particularly useful when adapters, or non-standard length spacers, are used to increase or decrease the separation of the circular saw blades from the separation the operator is familiar with.

As previously discussed, the prior art first mounting plate 125 is welded onto the blade drive shaft 125. This provides a weak point in the machine when in use. Milling of material is common in some heavy industries to provide strong components, however it has major drawbacks in terms of energy requirements and time required to form the components. These drawbacks are particularly prevalent when forming low volume components from high volume blocks of raw material. Milling an integral first mounting plate 225 and blade drive shaft 220 from a single block of raw material has shown in this application to outweigh the drawbacks of energy requirements and time, due to the extremely strong blade drive shaft with integral first mounting plate which is formed from the milling operation.

As the length of the blade drive shaft 220 is around 698 mm, and the diameter of the integral first mounting plate 225 is around 92 mm, milling is performed from a rectangular block of raw material with a width of at least 92 mm, a height of at least 92 mm and a length of at least 698 mm.

The above mentioned road saw 200 can be used to cut trenches which are 200 mm wide. In fact, if the blades are 7 mm thick, and the spacer 226 is 200 mm long, the actual width of the trench is 214 mm, or about 220 mm. It is to be understood that a trench width W can refer to an actual width which may be up to W+20 mm. Typically, as shown above, the largest trench width with a standard road saw 100 is around 100 mm. It is highly desirable to cut a larger trench width than the footprint of rammer available, or deployed to the site where the trench is to be cut and filled. The provision of a smaller rammer footprint than trench ensures that the personnel carrying out the compaction with the rammer must pass over the trench twice to compact all of the aggregate material. This would not be required if the trench is the same width as the rammer. For this reason, a wide road saw and standard rammer is highly desirable.

A road saw 200 with the adaptations mentioned above can be used in a method of forming and filling a trench with a width greater than 165 mm, and preferably around 200 mm, using at least two passes of a standard width rammer.

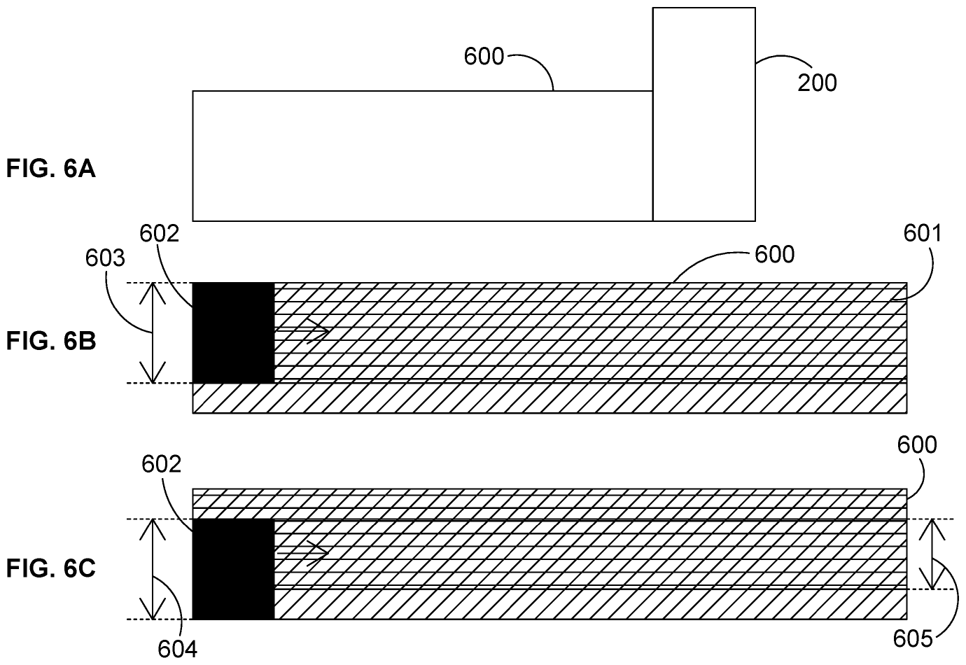

This method is described with reference to FIGS. 6a, 6b and 6c. FIG. 6a is a plan view of a road saw 200 configured and assembled to perform a trench cutting operation forming a trench 600 of around 200 mm wide. After the trench 600 has been formed, the trench 600 is filled with aggregate material 601 to a depth corresponding to the maximum depth for that layer of material to achieve the appropriate compaction. A trench rammer 602 is then passed over a first portion 603 of the aggregate material in a first pass where the rammer provides compaction to the aggregate material as shown in FIG. 6b. The first portion 603 is a portion of the entire trench area to be compacted. In some instances, the entire trench area cut by the road saw may not require compaction with the rammer, if for example a special type of compaction or other specific layers of aggregate material are required in one area of the trench. In this regard, the entire trench area to be compacted is herein referred to as the total portion, which may be the entire trench or a part of it. After the rammer 602 has compacted the first portion 603, the operator will observe that not all of the total portion has been compacted, and a second pass of the rammer 602 is required.

In this regard, the operator is forced to make a second pass, even though only a relatively small portion of the aggregate material has not been compacted. This provides the advantage of ensuring that a second pass is always made, which provides better overall compaction of the aggregate material when compared with a single pass.

Referring now to FIG. 6c which shows the rammer 602 in position to make a second pass. It will be understood that the rammer 602 will pass over and provide compaction to a second portion 604. The second portion 604 overlaps with the first portion 603 in the third portion 605. This third portion 605 is preferably a proportionally large area with respect to the area of the total portion of the trench to be compacted. It will be understood that the rammer 602 may make passes in either direction, and that both the first and second pass may be in the same direction or in opposite directions.

The rammer 602 used in the method has a footprint with a width smaller than the width of the trench 600. Some of the largest common rammer footprint widths available are around 165 mm, thus using a standard footprint rammer with a trench greater than 165 mm wide, such as around 200 mm wide, forces the operator to make two passes, and provide compaction twice to a large proportion of the surface area of the trench. This method overcomes the aforementioned issues in the construction industry relating the operators having a tendency to avoid a second pass with the rammer where possible, thus leading to a higher quality fill of a trench.

1. A blade drive shaft assembly for a road saw comprising a shaft, a first mounting plate, a spacer removably fitted on the shaft, a second mounting plate removably fitted on the shaft, a mounting plate fixing adapted to secure the second mounting plate to the shaft, a first circular saw blade mounted between the first mounting plate and the spacer, and a second circular saw blade mounted between the second mounting plate and the spacer, wherein the first mounting plate is integrally formed with the shaft from a single piece of metal.

2. The blade drive shaft assembly of claim 1, wherein the shaft has a diameter greater than 25 mm.

3. The blade drive shaft assembly of claim 2, wherein the shaft has a diameter of between 26 mm and 35 mm.

4. The blade drive shaft assembly of claim 1 wherein the blade drive shaft and the first mounting plate comprise EN19 hardened steel.

5. A road saw for cutting a trench in a road, comprising:
a road saw body;
an engine mounted to the road saw body;
the blade drive shaft assembly according to any preceding claim rotatably supported by a bearing mounted to the road saw body;
a transmission means driveably coupling the engine and the shaft;
wherein the first mounting plate, the spacer, the second mounting plate and the first and second circular saw blades are provided on a portion of the shaft cantilevered from the bearing, wherein the first and second blades are arranged 200 mm apart.

6. The road saw of claim 5, wherein the spacer has an axial length greater than 100 mm.

7. The road saw of claim 6, wherein the spacer has an axial length greater than 165 mm.

8. The road saw of claim 7, wherein the spacer has an axial length of 200 mm.

9. The road saw of claim 5, further comprising an adapter for use in conjunction with the spacer, and for providing additional separation between the first and second blades.

10. A method of forming, filling and compacting a trench comprising the steps of:
providing the road saw of claim 5;
cutting a trench having a width of at least 200 mm using said road saw;
at least partially filling said trench with aggregate material; and
compacting a total portion of said aggregate material by passing over the aggregate material with a rammer comprising a footprint with a width less than the width of the trench.

11. The method of claim 10, wherein the width of the footprint is at least 30 mm less than the width of the trench.

12. The method of claim 10 wherein the step of compacting a total portion of said aggregate material comprises the steps of:
compacting a first portion of the total portion having a first surface area with the rammer in a first pass; and
compacting a second portion of the total portion having a second surface area with the rammer in a second pass;
wherein the first and second surface areas at least partially overlap.

13. The method of claim 12, wherein the steps of compacting the first portion and compacting the second portion together complete the compaction of all of the aggregate material in the trench.

14. The method of claim 12, wherein a third portion which comprises part of the first and second portions is compacted in the first pass and the second pass.

15. The method of claim 10, wherein the road saw is a road saw according to claim 5.

16. A method of forming a blade drive shaft for a road saw, comprising the steps of providing a block of raw material and milling the raw material to provide a shaft and an integral first plate.

17. The method of claim 16, wherein the raw material is EN19 steel.

18. The method of claim 17, further comprising the step of hardening the blade drive shaft.

19. A method of making a blade drive shaft assembly according to claim 1, including the step of forming the blade drive shaft according to the method of claim 16.
